(19) United States
(12) Patent Application Publication
(10) Pub. No.: US 2009/0304425 A1
(43) Pub. Date: Dec. 10, 2009

(54) DOCUMENT READING APPARATUS

(75) Inventors: Masashi AOKI, Tokyo (JP); Hideyuki UMENO, Sagamihara-shi (JP)

Correspondence Address: FRISHAUF, HOLTZ, GOODMAN & CHICK, P.C., 16th Floor, 220 Fifth Avenue, New York, NY, 10001-7708, US

(73) Assignee: KONICA MINOLTA BUSINESS TECHNOLOGIES, INC., Tokyo (JP)

(21) Appl. No.: 12/329,434

(22) Filed: Dec. 5, 2008

(30) Foreign Application Priority Data
Jun. 5, 2008 (JP) JP2008-147829

(51) Int. Cl. G03G 15/00

(52) U.S. Cl. 399/367

(57) ABSTRACT

A document reading apparatus includes a first reading section for reading a first side of a document and a second reading section for reading a second side of the document, wherein a first reading position and a second reading position are disposed front and back in a conveyance direction at the document conveyance path, and wherein a pre-reading conveyance section and a post reading conveyance section which sandwich the first reading position and the second reading position in the conveyance direction are provided and the document is conveyed at the first reading position and at the second reading position by a conveyance section consisting of the pre-reading conveyance section and the post reading conveyance section, and wherein a conveyance force of the post reading conveyance section is equal to or less than a conveyance force of the pre-reading conveyance section.

### CROSS REFERENCE TO RELATED APPLICATION

The present application is based on Japanese Patent Application No. 2008-147829 filed with Japan Patent Office on Jun. 5, 2008, the entire content of which is hereby incorporated by reference.

### BACKGROUND OF THE INVENTION

1. Field of The Invention

The present invention relates to a document reading apparatus which reads a document and generates image data, and especially relates to a document reading apparatus for reading a double sided document.

2. Description of Related Art

A document reading apparatuses for reading the double sided document which comprises a first reading section for reading a first side of the double sided document and a second side reading section for reading a second side of the double sided document, wherein a first reading position of the first side reading section and a second reading position of the second side reading section are disposed along a document conveyance path therein, and conducts a double sided reading in a process of conveying the document in one direction is developed and is put to practical use, as disclosed in Unexamined Japanese Patent Application Publication No. 2005-96951.

The document reading apparatuses of this type are put to practical use as a fast speed document reading apparatus because these document reading apparatuses read documents more efficiently compared to document reading apparatuses which have one reading section, conveys the documents two times to the one reading section and thereby conduct the double sided reading.

In Unexamined Japanese Patent Application Publication No. 2005-96951, a prevention of reading accuracy reduction generated by a misalignment caused by an image reading section on a platen roller is proposed.

The documents are conveyed in the document conveyance path which has a plurality of conveyance rollers and a plurality of guide members. The first reading position of the first side reading section and the second reading position of the second side reading section are disposed front and back in a conveyance direction of the document conveyance path.

In the document reading apparatus disclosed in Unexamined Japanese Patent Application Publication No. 2005-96951, a conveyance roller is disposed between the first reading position and the second reading position.

Additionally, a conveyance roller is disposed on an up stream of the first reading position as well as a conveyance roller (feed out roller) is disposed on a down stream of the second reading position.

FIG. 1 shows the relation of position between the reading positions and the conveyance rollers disclosed in Unexamined Japanese Patent Application Publication No. 2005-96951.

A first conveyance toller H1 is disposed at an up stream of the first reading position Y1 and a second conveyance roller H2 is disposed at a down stream of the second reading position Y1, as it is obviously understood from FIG. 1.

Further, the second roller H2 is disposed at an up stream of the second reading position Y2 and a third conveyance roller H3 is disposed at a down stream of the second reading position Y2.

The reference W is a direction of the conveyance of the documents.

In the configuration comprising the first reading position and the second reading position, the documents at the first reading position are conveyed by the first conveyance roller H1 and the second conveyance roller H2 and the documents at the second reading position are conveyed by the second conveyance roller H2 and the third conveyance roller H3.

The conveyance rollers H1, H2, and H3 have the same conveyance speed as a design value, however it is inevitable that there is a case that each conveyance roller has a different conveyance speed because of variations of accuracy of parts and changes with time.

In FIG. 1, the rollers which convey documents at the first reading position and the rollers which convey the documents at the second reading position are different. Therefore, there occurs a difference between the conveyance speed at the first reading position and the conveyance speed at the second reading position in case when the conveyance speeds of the conveyance rollers H1, H2, and H3 become unequal.

As a result, longitudinal magnifications, that are magnifications in the conveyance direction, of front surface read image and of back surface read image are different from each other.

In Unexamined Japanese Patent Application Publication No. 2005-96951, preventing lowering of reading accuracy caused by a shift of the image reading position is disclosed. However above described problem of the magnification difference between the front surface read image and the back surface read image can not be prevented.

### SUMMARY

One aspect of the present invention is a document reading apparatus including:

a document conveyance path;

a first reading section for reading a first side of a document; and

a second reading section for reading a second side of the document, wherein a first reading position of the first reading section and a second reading position of the second reading section are disposed front and back in a conveyance direction at the document conveyance path, and

wherein a pre-reading conveyance section and a post reading conveyance section which sandwich the first reading position and the second reading position in the conveyance direction are provided and the document is conveyed at the first reading position and at the second reading position by a conveyance section consisting of the pre-reading conveyance section and the post reading conveyance section, and

wherein a conveyance force of the post reading conveyance section is equal to or less than a conveyance force of the pre-reading conveyance section.

### BRIEF DESCRIPTION OF THE DRAWINGS

FIG. 1 is a drawing for explaining an occurrence of a magnification difference of images read between a front side and a back side;

FIG. 2 is an overall diagram of the document reading apparatus relating to the embodiment of the present invention;

FIG. 3 is a cross sectional drawing of main parts of the document reading apparatus shown in FIG. 2;

FIG. 4 is a plan view of the conveyance roller 6 and the guide plate 31; and

FIG. 5 is a diagram showing a relation of the first reading position Y1, the second reading position Y2, and the post reading conveyance section.

### DETAILED DESCRIPTION OF THE PREFERRED EMBODIMENTS

The preferred embodiments of the present invention will be described below, however, the present invention is not construed to be restricted to these embodiments.

In the following description, the wordings of “front”, “back”, “up stream” and “down stream” are used in reference to the conveyance direction of the document.

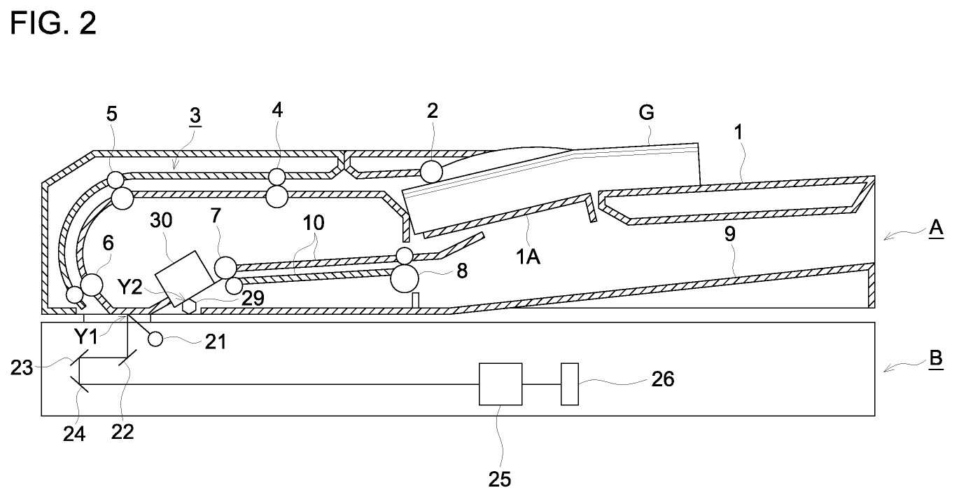

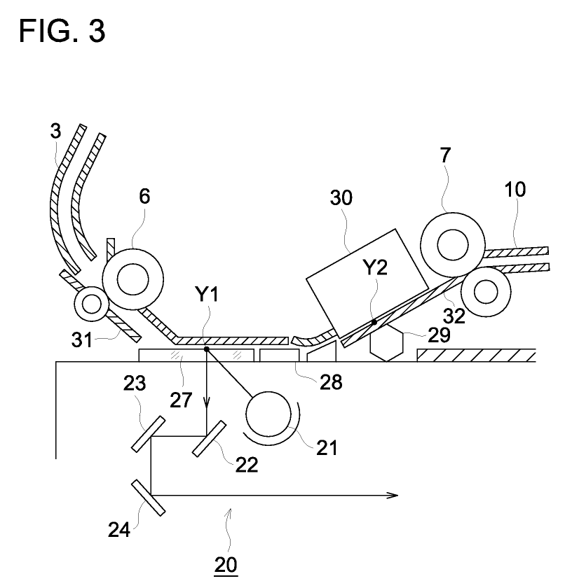

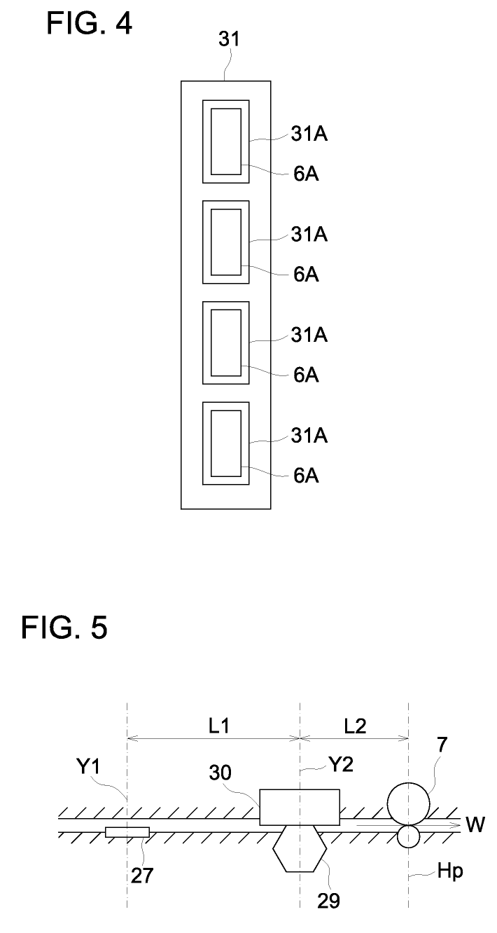

FIG. 2 is an overall diagram of a document reading apparatus relating to the preferred embodiment of the present invention. FIG. 3 and FIG. 4 are a cross sectional drawings of important parts of the document reading apparatus shown in FIG. 2.

The document reading apparatus comprises a document conveyance device A and a reading section B. The document conveyance device B is disposed on the reading device A.

The document conveyance device A comprises a document supply section 1 in which a plurality of documents G are stacked and a document delivery section 9 in which the documents G delivered after being read are stacked. The documents G are supplied one by one.

A document conveyance path is formed between the document supply section 1 and the document delivery section.

The document conveyance path comprises a plurality of conveyance rollers and guide members for guiding the documents G.

A reference numeral 2 is a feed roller. The documents G are pressed to the feed roller 2 by a movable press plate 1A which is disposed at the document supply section 1.

Reference numerals 4, 5, 6 and 7 are conveyance rollers each of which comprises a drive rollers and a driven roller. A guide 3 is disposed between each conveyance roller. A guide plate 10 is provided at a down stream of the conveyance roller 7 and a delivery roller 8 is provided at a down stream of the guide plate 10.

The documents G stacked at the document supply section 1 are fed sequentially out one by one from a top thereof by the feed roller 2, conveyed through a U-shaped document feed path, delivered out by the delivery roller 8 and stacked at the document delivery section 9.

The reference numeral 30 is a second read section and comprises a contact image sensor (after here described as CIS).

The CIS 30 focuses incident light on an image capturing element therein through a light focusing fiber and reads image.

The CIS 30 reads a second surface of the documents at the second reading position Y2.

The second reading position Y2 which is the reading position of CIS 30 is disposed at the conveyance path between the conveyance roller 6 as a pre-reading conveyance section and the conveyance roller 7 as a post reading conveyance section.

The reading section B comprises the first reading section 20. The first reading position Y1 of the first reading section 20 is an approximate middle position in the document conveyance direction of a slit glass 20. The first reading position Y1 locates between the conveyance roller 6 and the conveyance roller 7, as well.

FIG. 4 is the plan view of a conveyance roller 6 and the guide plate 31.

The guide plate 31 which forms the conveyance path just upstream of the first reading position Y1 forms a part of the guide member 3 and a hole 31 for receiving roller element 6A which is included by the conveyance roller 6 is provided at the guide plate 31.

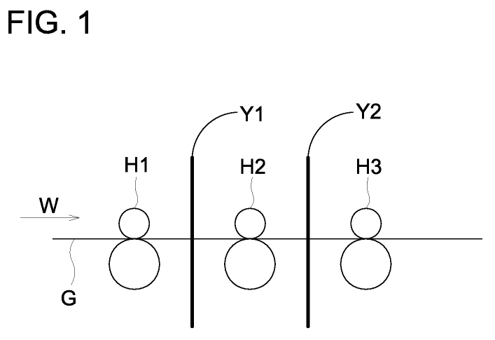

As shown in FIG. 1 and FIG. 3, it is possible to provide the conveyance roller 6 at a very near position to the first reading position Y1 by configuring these types of the guide members and conveyance rollers.

By disposing the conveyance roller 6 and the first reading position very near each other, it is possible to obtain sharp reading image because the conveyance of the documents G becomes stable.

The first reading section 20 comprises a light source 20 for irradiating the documents, a plurality of mirrors 22, 23 and 24 for guiding reflected light from the documents to an image capturing element 26, a lens 25 for focusing the reflected light from the documents on the image capturing element 26, and the image capturing element 26.

The image capturing element 26 comprises a line CCD, for example.

A reference numeral 27 is a slit glass for transmitting incident reflected light to the documents G and reference numerals 28 and 29 are reference white members.

Data obtained by reading a white surface of the reference white members 28 and 29 is used for shading correction.

The reference white member 29 comprises a plate shaped member having a white surface at the bottom thereof and the reference white member 28 comprises a hexagonal shaped member having white peripheral surfaces thereof.

In case when the white surface is needed to be replaced by such a reason that the white surface is dusted, the reference white member 29 is configured to rotate so that a new white surface is set at a read position.

The reference white members for shading correction are needed to be disposed near the image reading positions. At the same time, the first reading position Y1 and the second reading position Y2 are disposed at the near position each other in order to make the document reading apparatus compact.

In such a construction, the space where the reference white members are disposed is limited very much.

As shown in FIG. 3, the document conveyance path between the first reading position and the conveyance roller 7 which is the post reading conveyance section is formed as an inclined path which is inclined higher at the down stream side thereof.

FIG. 5 is a diagram showing a relation of positions of a first reading position Y1, a second reading position Y2, and the post reading conveyance section, by expanding the curved conveyance reaching from the first reading position to the conveyance roller 7 to a straight conveyance path.

As shown in FIG. 5, the CIS 30 and the reference white member are disposed so as to satisfy a relation that, in the conveyance path between the first reading position Y1 and the conveyance position Hp of the conveyance roller 7, a distance L2 between the second reading position Y2 and the conveyance position Hp of the conveyance roller 7 is shorter than a distance L1 between the first reading position Y1 and the second reading position Y2.

By the disposition of the reference white member 29, the reference white member 29 is disposed below the inclined path and the reference white member 29 can disposed in the compact document reading apparatus. Further, by employing the polygonal shaped reference white member 29, it becomes possible for the reference white member 29 to be used for a long time by changing and using the each surface of the polygonal shape.

The document G which passes above the slit glass 27 is irradiated by a light source 21, the reflected light of the documents G is lead to the image capturing element 26 by the mirrors 22 to 23, and reading of the first surface of the documents G is conducted by the first image reading section 20.

The first image reading position Y1 is disposed at the conveyance path between the conveyance roller 6 as the pre-reading conveyance section and the conveyance roller 7 as the post reading conveyance section, same as the second image reading position Y2.

When the document G fed out by the feed roller 2 passes through the first image reading position, the first surface is read by the first reading section 20.

After passing through the first image reading position, the document G passes through the second reading position, at the time of passing through, the second surface is read by the CIS 30.

After the first surface and the second surface are read, the document G is delivered to the document delivery section 9.

At the document reading position Y1 and at the second document reading position Y2, the document G is conveyed by the same conveyance section comprising the conveyance roller 6 as the pre-reading conveyance section and the conveyance roller 7 as the post reading conveyance section.

Therefore the conveyance speed of the document at the first reading position Y1 becomes always equal to the conveyance speed of the document at the second reading position Y2.

For example, even when the conveyance speeds of the conveyance roller 6 and the conveyance roller 7 change by the variation with time, the conveyance speed of the document at the first reading position Y1 is always equal to the conveyance speed of the document at the second reading position Y2.

Further, it is preferred that a conveyance force of the conveyance roller 7 is less than a conveyance force of roller 6 in order to stabilize the conveyance speed at the first reading position and the second reading position.

That is, it is preferred that a nip force of a pair of rollers which make up the conveyance roller 6 is less than a nip force of a pair of rollers which make up the conveyance roller 7. Or it is preferred that a friction coefficient of the pair of rollers which make up the conveyance roller 6 is less than a friction coefficient of the pair of rollers which make up the conveyance roller 7.

By configuring as disclosed in the embodiment, especially when conveying the documents including thick documents and so on, the documents are conveyed smoothly into the pair of rollers which make up the conveyance roller 7.

Therefore, a speed variation of the conveyance hardly occurs.

According to the preferred embodiment of the present invention, at the document reading position Y1 for reading the first surface of the document and at the second document reading position Y2 for reading the second surface of the document, the document is conveyed by the same conveyance section. Therefore the image of the front surface side and the image of the back surface side are read always with the same magnification and the problem that a difference of magnification between the front surface side and the image of the back surface side is generated is solved.

What is claimed is:

1. A document reading apparatus comprising:
a document conveyance path;
a first reading section for reading a first side of a document; and
a second reading section for reading a second side of the document, wherein a first reading position of the first reading section and a second reading position of the second reading section are disposed front and back in a conveyance direction at the document conveyance path, and
wherein a pre-reading conveyance section and a post reading conveyance section which sandwich the first reading position and the second reading position in the conveyance direction are provided and the document is conveyed at the first reading position and at the second reading position by a conveyance section consisting of the pre-reading conveyance section and the post reading conveyance section, and
wherein a conveyance force of the post reading conveyance section is equal to or less than a conveyance force of the pre-reading conveyance section.

2. The document reading apparatus of claim 1, wherein a guide plate for guiding the document is disposed at a place where the pre-reading conveyance section is disposed on the document conveyance path and the guide plate has a hole receiving the pre-reading conveyance section.

3. The document reading apparatus of claim 1, provided with
a reading section having the first reading section and
a document conveyance apparatus disposed on the reading section, the document conveyance apparatus having,
the document conveyance path;
the second reading section;
a reference white member disposed at a place facing to the second reading section;
a document supply section which feeds the document to the document conveyance path; and
a document delivery section, wherein the conveyance path between the first reading position and the document delivery section comprises an inclined conveyance path for conveying the document upwards, and
wherein the second reading position and the reference white member locate at the inclined path nearer to the post reading conveyance section than the first reading position locates to the post reading conveyance section.

4. The document reading apparatus of claim 31 wherein the reference white member comprises a polygonal shaped member which has white peripheral surfaces.
